(19) United States
(12) Patent Application Publication
(10) Pub. No.: US 2018/0375980 A1
(43) Pub. Date: Dec. 27, 2018

(54) Phone Stand Case

(71) Applicants: Ray Anthony Renfrow, Champaign, IL (US); Darlene Rachelle Severin, Champaign, IL (US)

(72) Inventors: Ray Anthony Renfrow, Champaign, IL (US); Darlene Rachelle Severin, Champaign, IL (US)

(21) Appl. No.: 15/633,740

(22) Filed: Jun. 26, 2017

(51) Int. Cl. H04M 1/11; F16B 2/10; F16M 11/04; F16B 2/00

(52) U.S. Cl. CPC H04M 1/11; F16B 2/005; F16M 11/041; F16B 2/10

(57) ABSTRACT

A versatile cell phone stand, with a bottom and top that folds out to hold the cell phone in place. Which can be used whenever a person wants to view their phone hands-free thereby permitting a user the ability to watch videos, play games, write messages, and use FaceTime, without exhausting their arms or developing cramps in their necks from maintaining an uncomfortable and unnatural position. The top has a clip that holds the cell phone in place.

### BACKGROUND OF THE INVENTION

### 1. Field of the Invention

The present invention relates generally to the field of stand devices and more specifically relates to a versatile stand, which will be used whenever a person wants to view their phone hands-free thereby permitting a user the ability to watch videos, play games, write messages, and use FaceTime, without exhausting their arms or developing cramps in their necks from maintaining an uncomfortable and unnatural position.

### 2. Description of the Related Art

People often want to use their cell phones without having to hold them in their hands. When it is lying flat on a table, it can be difficult to see the screen clearly. People can develop pain in their necks when they tilt their heads down to watch videos or movies and when reading e-books on their phones. A person's hands and arms can get sore and tired holding the phone at an angle, which makes the screen easier to see, for an extended period of time. Therefore a need exists for a specially designed stand that allows users to sec their phones at a comfortable angle, without having to hold them in their hands ideal for users watching movies. YouTube videos, Face liming, listening to music, or reading e-books with their phones.

It is extremely difficult to use the screen of a cell phone on a soft surface like a bed or sofa. Various attempts have been made to solve the problems which may be found in the related art but have thus far been unsuccessful. A need exists for a reliable Phone stand case to avoid the above-mentioned problems.

### BRIEF SUMMARY OF THE INVENTION

In view of the foregoing disadvantages inherent in the known art, the present invention provides a novel phone stand case. The general purpose of the present invention, which will be described subsequently in greater detail below, is to provide a versatile stand, which will be used whenever a person wants to view their phone hands-free thereby permitting a user the ability to watch videos, play games, write messages, and use FaceTime, without exhausting their arms or developing cramps in their necks from maintaining an uncomfortable and unnatural position. The features of the invention which are believed to be novel are particularly pointed out and distinctly claimed in the concluding portion of the specification.

The phone stand case w ill have a top and bottom connected by a hinge. The hinge opening up at a 45 degree angle. The top will have a swing out clip which swings out from the top to clasp on to the cell phone to hold it in place so that the cell phone is held at a 45 degree angle for easy viewing.

These and other features, aspects, and advantages of die present invention will become better understood with reference to the following drawings and detailed description.

### BRIEF DESCRIPTION OF THE DRAWINGS

The figures which accompany the written portion of this specification illustrate embodiments and method(s) of use for the present invention, phone stand case, constructed and operative according to the teachings of the present invention.

FIGS. 1-7 show various perspective views illustrating phone stand case according to an embodiment of the present invention.

The various embodiments of the present invention will hereinafter be described in conjunction with the appended drawings.

### DETAILED DESCRIPTION

As discussed above, embodiments of the present invention relate to a stand device and more particularly to a cell Phone stand.

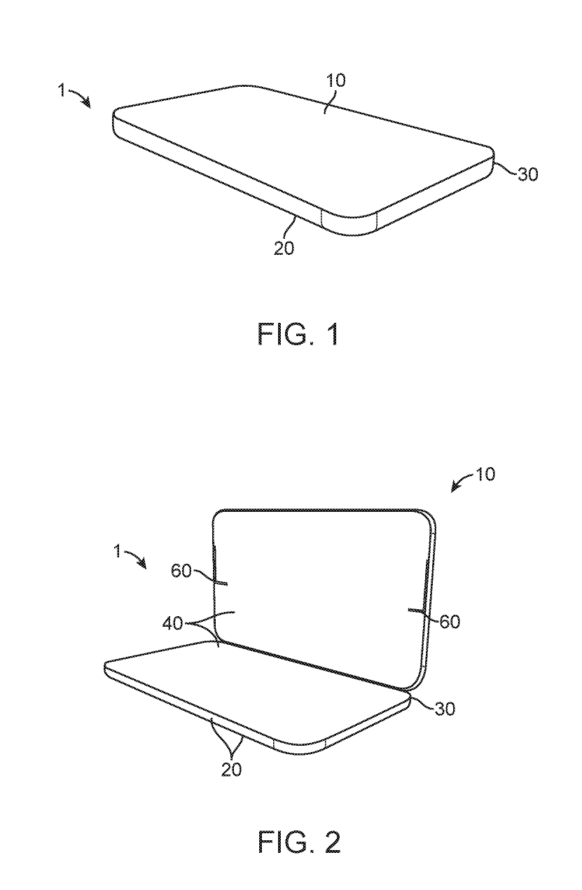

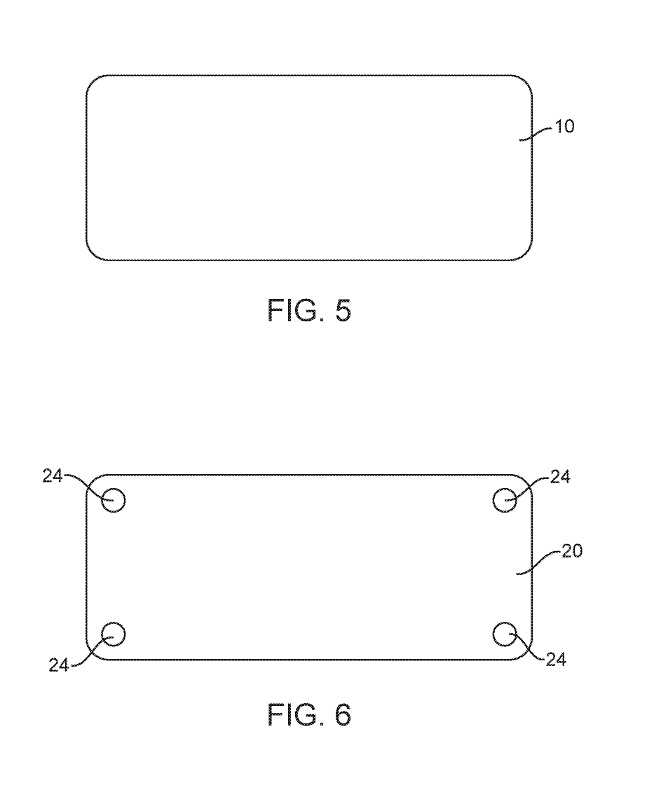

Referring now to the drawings FIGS. 1-7, the device is a phone stand case 1 that provides a convenient way to hold a cell phone 100 hands-free when it is being used for entertainment. It is made of plastic and rubber. The phone stand case 1 is designed to rest on both hard surfaces, like a table, or soft surfaces, like a sofa or bed.

As shown in FIG. 1, the phone stand case 1 folds into a case with a bottom part 20 and a top part 10. The bottom part 20 and top part 10 will have a smooth outside shell made of a material like a harden plastic.

The device 1 has a top 10 that flips up to hold the phone securely at a 45-degree angle between a stationary bottom 20 and the open top 10. A Standard Assembly Hinge 30 is used to connect the two pieces, which will keep the top 10 open without wanting to close. When the device 1 is opened a phone 100 can be placed at the desired angle between the top 10 and bottom 20 with the bottom edge of the phone 100 resting on the bottom side 10 with the top of the phone resting against the top side 10 at an angle for easy viewing. The angle of the phone 100 can be adjusted for better viewing.

The device 1 will have a rubber stopper 40 across the bottom 20 and top 10 at the inside open side, which prevents the phone 100 from slipping.

The bottom side 20 has a thin layer of rubber 23 on the outside of the bottom 20 over the shell to prevent the stand from slipping, especially when it is being used in a moving vehicle. The bottom 20 has a weight layer 25 which provides weight which serves to stabilize the stand 1 when it holds a cell phone 100 as shown in the cross-cut section in FIG. 4. The weighted layer 25 is in the middle of the bottom side 20 between the rubber layer 23 and the shell.

In an alternative embodiment, as shown in FIG. 6, the bottom 20 has a plurality of thin rubber legs 24 instead of the thin layer of rubber 23. The rubber legs 24 can be round in shape or can be strips. This embodiment provides the stability and prevention of slippage while not have a need to have the whole bottom side 20 covered in rubber.

The device 1 has a layer of rubber 40 in the inside of both the top 10 and bottom 20 of the stand 1 to prevent the phone from slipping while leaning against the open top.

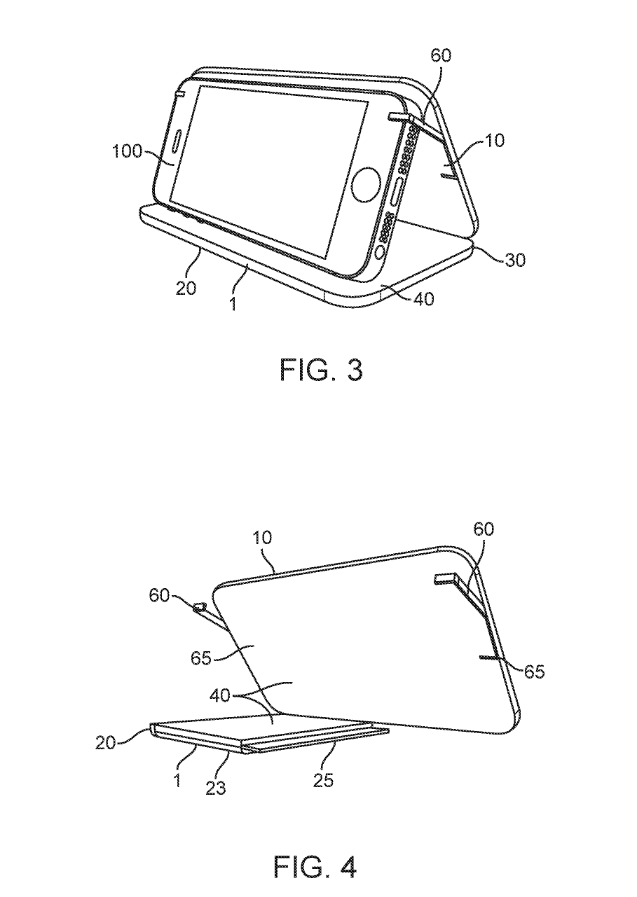

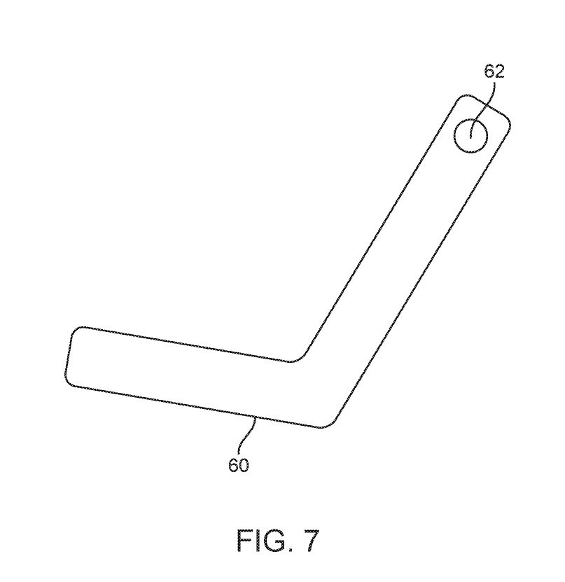

The device 1 has a lightweight metal clamp 60 with a rubber end (tip) to hold the phone in place without scratching the screen as shown in FIG. 3 The metal clamp 60 is connected by a pin to the top 10 of the stand 1 and rotates on that pin 62 as shown in FIG. 7. The metal clamp 60 rotates out from the top side 20 onto the phone 100 to hold it in place. The metal clamp 60 extends perpendicular from the lop side 20. The metal clamp 60 bends at a 90 degree angle to hold die phone 100. When not extended, the metal clamp 60 is stored in the metal clamp indentation 65 where it is flush with the inside surface of the top.

### Advantages

The current invention is a convenient way to support all makes and models of phones at an angle, so they can be viewed easily when following a recipe, following GPS directions, or watching a movie or video. This stand will be available in different sizes for different-sized phones, as well as various colors to appeal to men and women of all ages.

The unique features of this invention will provide the following benefits for all consumers. It is a versatile stand to support a cellphone at a comfortable angle, so its screen can be seen easily, without having to be hand-held. Its simple design makes it very affordable for all those who use their phones for watching videos and movies, reading e-books, searching the Internet, and following social media updates. The phone stand case provides support for the phone preventing damage to the phone from the phone falling backwards, or the screen from cracking when falling forward. It is designed to be stable on hard surfaces, like a table, or soft surfaces, like a bed or a sofa. It can eliminate the development of painful necks and tired arms, which can result when using the phone in an awkward position for an extensive length of time. It is portable and easy to use, without interfering with the normal use of the phone. It is portable and does not attach to the phone, so there is no added bulk when the phone is carried in one's pocket or purse, it will allow users to watch their phones while doing other activities, such as preparing a meal, or rocking a baby.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursor, inspection the nature and essence of the technical disclosure of the application.

1. A Phone stand device comprising:
A top connected to a bottom by a single hinge where the top opens up at a 45 degree angle from the bottom with a clamp connect to the top by a rotating pin that clamps a cell phone to hold it in place and where the top and bottom folds together where the bottom has a weight layer.

2. A device according to claim 1 further comprising:
Said clamp have a rubber tip.

3. A device according to claim 1 further comprising;
Where the clamp can be folded into a clamp slot in the top.

4. A device according to claim 1 further comprising;
Where the bottom has a rubber grip bottom layer.

5. (canceled)

6. A device according to claim 1 further comprising;
Where there are a plurality of rubber legs on the bottom.

7. A device according to claim 1 further comprising;
Where the bottom and the top has an inside rubber layer.

8. (canceled)

9. (canceled)

10. A Phone stand device comprising:
A top connected to a bottom by a single hinge where the top opens up from the bottom at a 45 degree angle and a clamp is connected by a rotating pin to the top of the stand and rotates on said pin clamps a cell phone to hold it in place and where the top and bottom folds together, where the clamp can be folded into a clamp slot in the top and where the bottom has a rubber grip bottom layer and a weight layer where the bottom and the top has an inside rubber layer.

11. A device according to claim 10 further comprising:
Said clamp have a rubber tip.

12. (canceled)

13. (canceled)

14. (canceled)

15. (canceled)

16. (canceled)

17. (canceled)

18. A device according to claim 10 further comprising;
Where the clamp extends perpendicular from the top.

19. A device according to claim 10 further comprising;
Where the clamp bends at a 90 degree angle to hold the phone.

20. A device according to claim 10 further comprising;
Where weighted layer is in the middle of the bottom between the rubber layer and a shell.
